(19) United States
(12) Patent Application Publication
(10) Pub. No.: US 2026/0253343 A1
(43) Pub. Date: Aug. 27, 2026

(54) Automatic Fixed-Radius Boundary for Artificial Reality Environments

(71) Applicant: Meta Platforms Technologies, LLC, Menlo Park, CA (US)

(72) Inventors: Audrey MULLER, San Francisco, CA (US); Christopher Richard TANNER, Highlands Ranch, CO (US); Shen LI, Foster City, CA (US); James Alexander VALORI, San Francisco, CA (US); Scott MOORE, Seattle, WA (US)

(21) Appl. No.: 19/064,352

(22) Filed: Feb. 26, 2025

(51) Int. Cl. G06T 19/00; G06V 20/20

(52) U.S. Cl. CPC G06T 19/006; G06V 20/20

(57) ABSTRACT

Aspects of the present disclosure provide an automatic fixed-radius boundary for accessing artificial reality (XR) experiences. Instead of requiring a user to look around a real-world environment with an XR system and/or trace the available floorspace for a boundary, an automatic boundary system can create a boundary of fixed size around the user by using depth sensing to dynamically identify obstacles within the boundary as the user moves. The automatic boundary system does not require identification of the objects themselves, nor does it require that the entire real-world space be scanned in areas far from the user (e.g., outside the fixed radius). As the automatic boundary system detects obstacles, the XR system can display the obstacle as a mesh or in pass-through based on fulfillment of one or more conditions (e.g., the XR system or a body part of the user approaching the obstacle).

### TECHNICAL FIELD

The present disclosure is directed to generating an automatic boundary with a fixed radius, relative to an artificial reality (XR) system, for XR environments.

### BACKGROUND

Artificial reality (XR) devices are becoming more prevalent. As they become more popular, the applications implemented on such devices are becoming more sophisticated. Mixed reality (MR) and augmented reality (AR) applications can provide interactive three-dimensional (3D) experiences that combine images of the real-world with virtual objects, while virtual reality (VR) applications can provide an entirely self-contained 3D computer environment. For example, an MR or AR application can be used to superimpose virtual objects over a real scene that is observed by a camera. A real-world user in the scene can then make gestures captured by the camera that can provide interactivity between the real-world user and the virtual objects. AR, MR, and VR (together XR) experiences can be observed by a user through a head-mounted display (HMD), such as glasses or a headset. An HMD can have a pass-through display, which allows light from the real-world to pass through a lens to combine with light from a waveguide that simultaneously emits light from a projector in the HMD, allowing the HMD to present virtual objects intermixed with real objects the user can actually see.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for automatically generating a boundary for an artificial reality (XR) experience.

FIG. 6 is a flow diagram illustrating a process used in some implementations of the present technology for generating a boundary, using data from multiple XR systems, for an XR experience.

FIG. 7A is a conceptual diagram illustrating an example view of a real-world environment in which an XR system has generated a fixed-radius boundary, surrounding the XR system and for accessing an XR experience, within which no hazard is detected.

FIG. 7B is a conceptual diagram illustrating an example view of a real-world environment in which an XR system has generated a fixed-radius boundary, surrounding the XR system and for accessing an XR experience, within which a hazard is detected.

FIG. 7C is a conceptual diagram illustrating an example view, on an XR system, of an XR experience in which a hazard, detected within a fixed-radius boundary of the XR system, is rendered in pass-through.

FIG. 8A is a conceptual diagram illustrating an example view of a real-world environment in which two XR systems have generated respective fixed-radius boundaries, and within which one XR system detects a hazard within both fixed radius boundaries.

FIG. 8B is a conceptual diagram illustrating an example view, on a second XR system, of an XR experience in which a hazard, detected with a fixed-radius boundary of the second XR system, is rendered as a mesh.

FIG. 8C is a conceptual diagram illustrating an example view, on a first XR system, of an XR experience in which a warning is displayed of a hazard, within a fixed-radius boundary of the first XR system, that is detected by a second XR system.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure provide an automatic fixed-radius boundary for accessing artificial reality (XR) experiences. Instead of requiring a user to look around a real-world environment with an XR system (e.g., an XR head-mounted display) and/or trace the available floorspace for a boundary, an automatic boundary system can create a boundary of fixed size around the XR system and use depth sensing to dynamically identify obstacles (e.g., physical objects) within the boundary. As the XR system moves about the real-world environment, the boundary can remain fixed in radial size and centered at the location of the XR system. The automatic boundary system does not require identification of the objects themselves, nor does it require that the entire real-world space be scanned in areas far from the user (e.g., outside the fixed radius). As the automatic boundary system detects obstacles, the XR system can display an indication of the obstacle, and, in some cases, based on fulfillment of one or more conditions (e.g., the XR system or a body part of the user approaching the obstacle). When the user is stationary (e.g., in a seated position), the XR system can automatically switch from the fixed-radius boundary to a stationary boundary and cease scanning of the real-world environment and/or updating of the boundary.

Aspects of the present disclosure further provide a multi-user fixed-radius boundary, where obstacles outside of the field-of-view of one XR system can be captured and shared by another XR system (e.g., for objects within the XR system's boundary, but not visible by the XR system, such as behind the XR system). In some implementations, the XR systems can have a shared localization map in which each system maps time-stamped depth data. The XR system can then use the depth data in the localization map to discover objects within its boundary, if those objects have not been scanned by the XR system and/or if that data is newer than data it itself gathered at a previous timestamp. In other implementations, the XR systems can share time-stamped images with camera location data that can be used by an XR system, as if it were one of its own cameras, to generate depth data for the area within its boundary. In some implementations, the XR systems can further share their own locations and/or locations of respective users'body parts, which can be used to determine if they are within the boundary of another user.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers. “Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

The implementations described herein provide specific technological improvements in the technical field of artificial reality. Some implementations can improve latency and the overall user experience by minimizing or eliminating manual boundary capture, setup, and/or designation, and reduce delay in rendering XR experiences. Further, some implementations only selectively scan a portion of a real-world environment, and only generate a boundary for that portion of the real-world environment (e.g., the portion surrounding the XR system within a threshold distance selected based on an area a user can interact with via their body, such as within arm or leg's reach). Thus, the XR system can conserve resources (e.g., processing power, battery power, etc.) that would otherwise be needed to scan, activate, and enforce a boundary for the entire real-world space. By providing boundaries for the XR environment, and, in some cases, by enforcing such boundaries, the XR system can reduce the possibility, risk, and/or occurrence of collisions between the user of the XR system and physical objects in the real-world space and/or other accidents (e.g., falling down the stairs).

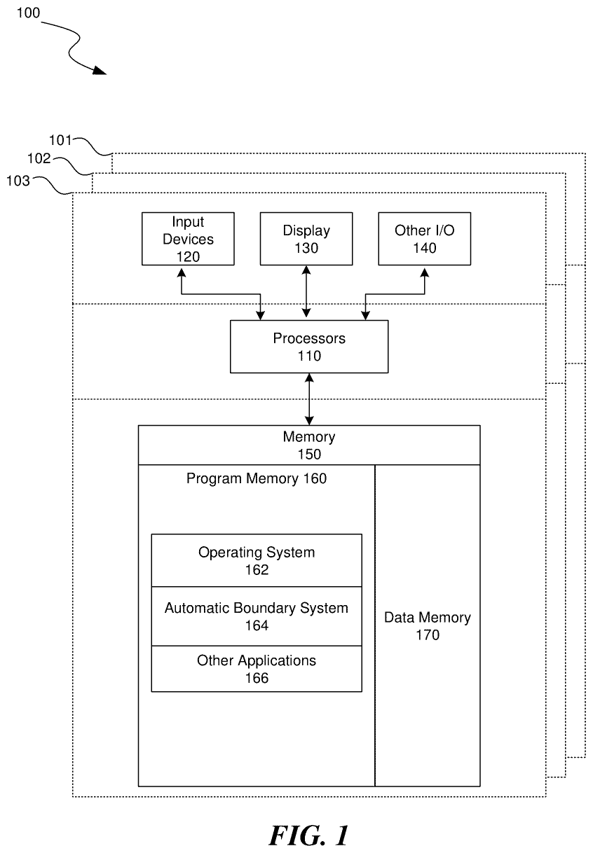

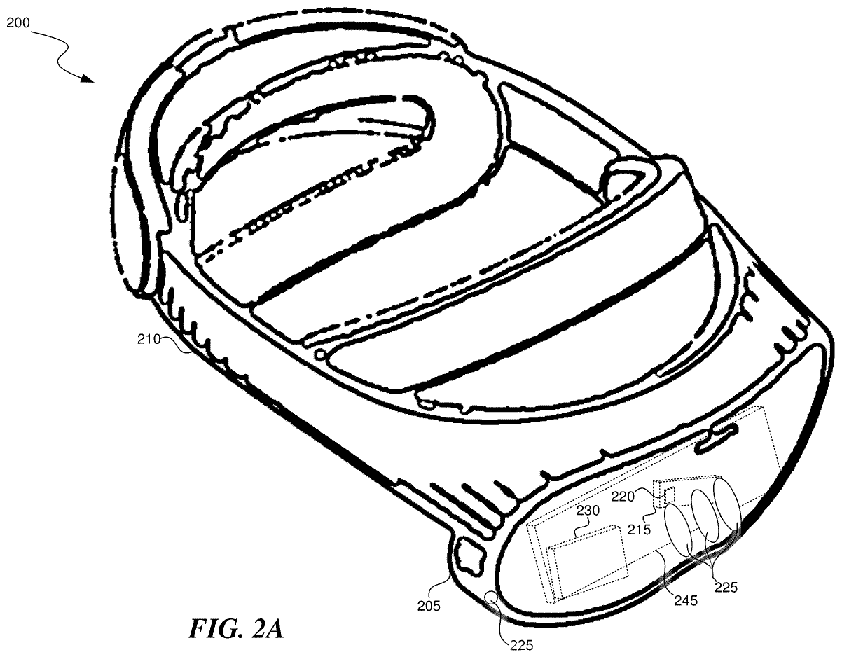

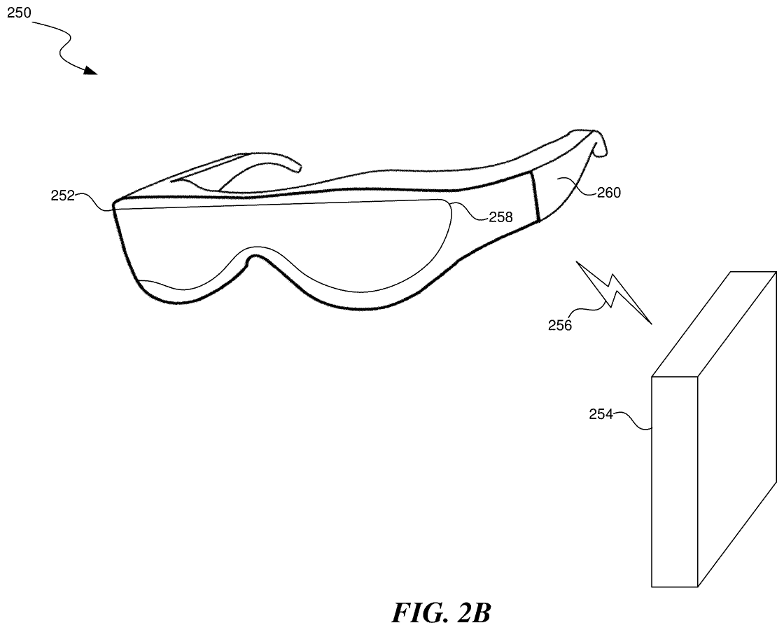

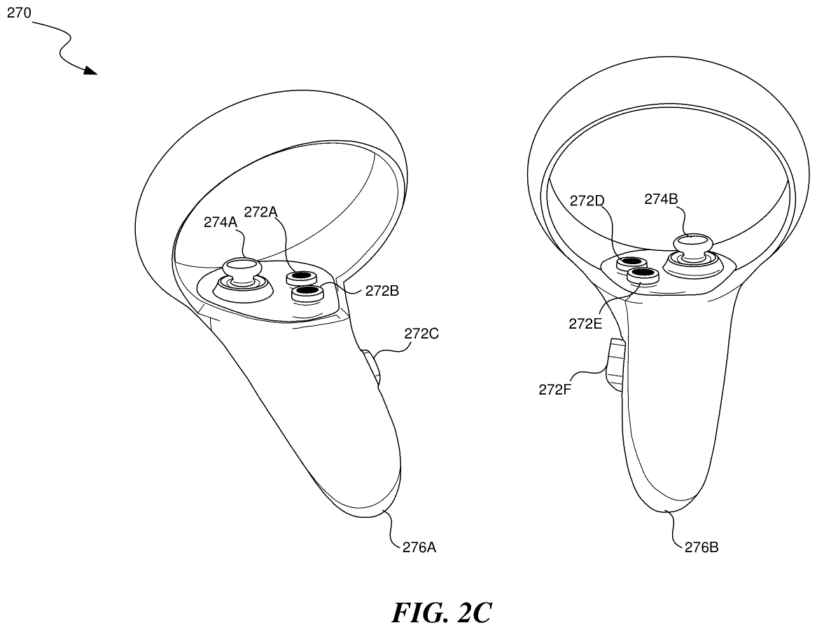

Several implementations are discussed below in more detail in reference to the figures. FIG. 1 is a block diagram illustrating an overview of devices on which some implementations of the disclosed technology can operate. The devices can comprise hardware components of a computing system 100 that can provide an automatic boundary for an artificial reality (XR) environment. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, automatic boundary system 164, and other application programs 166. Memory 150 can also include data memory 170 that can include, e.g., real-world environment data, characteristic data, depth data, object data, mesh data, rendering data, notification data, movement data, boundary data, hazard data, configuration data, settings, user options or preferences, etc., which can be provided to the program memory 160 or any element of the computing system 100.

In various implementations, the technology described herein can include a non-transitory computer-readable storage medium storing instructions, the instructions, when executed by a computing system, cause the computing system to perform steps as shown and described herein. In various implementations, the technology described herein can include a computing system comprising one or more processors and one or more memories storing instructions that, when executed by the one or more processors, cause the computing system to steps as shown and described herein.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an artificial reality environment in three degrees of freedom (3DoF) or six degrees of freedom (6DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

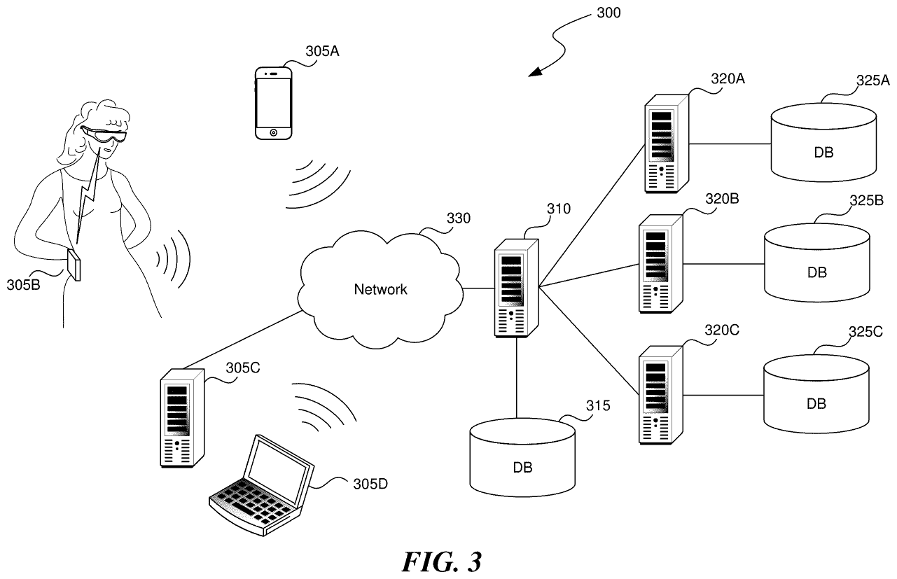

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

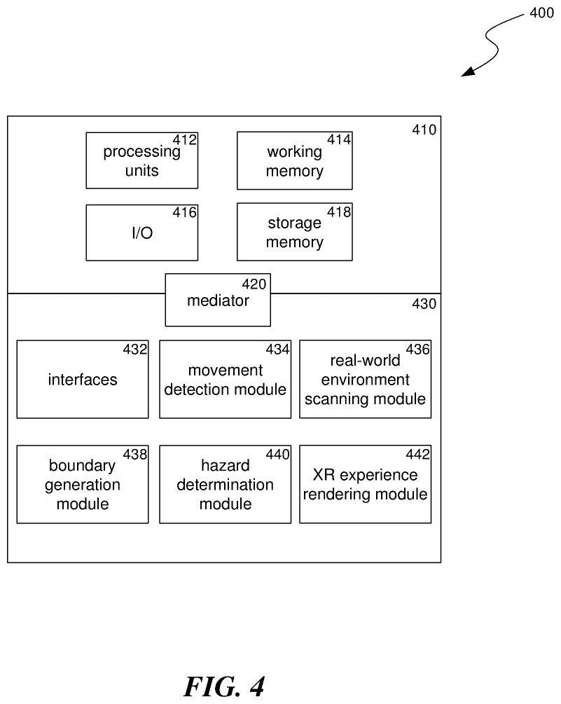

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for providing an automatic boundary for an artificial reality (XR) environment. Specialized components 430 can include movement detection module 434, real-world environment scanning module 436, boundary generation module 438, hazard determination module 440, XR experience rendering module 442, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

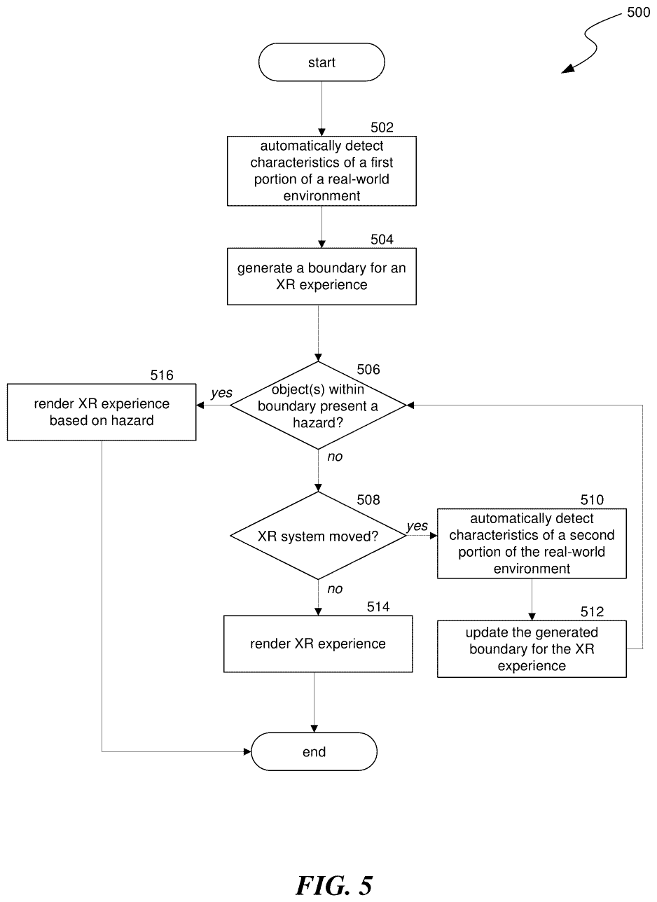

In some implementations, movement detection module 434 can detect movement of an XR system in a real-world environment. In some implementations, movement detection module 434 can detect movement of the XR system based on images captured by one or more cameras of the XR system (such as included in input/output devices 416). For example, by analyzing consecutive images of the real-world environment (or images otherwise captured at different timestamps) from the same camera, movement detection module 434 can determine that the XR system has moved because the view of the camera has changed. In some implementations, movement detection module 434 can detect movement based on changing depth detections by one or more sensors of the XR system. In some implementations, movement detection module 434 can detect movement based on data collected from one or more sensors integral with the XR system, such as sensors of an inertial measurement unit (IMU) (e.g., accelerometer, gyroscope, etc.). Further details regarding detecting movement of an XR system in a real-world environment are described herein with respect to block 508 of FIG. 5.

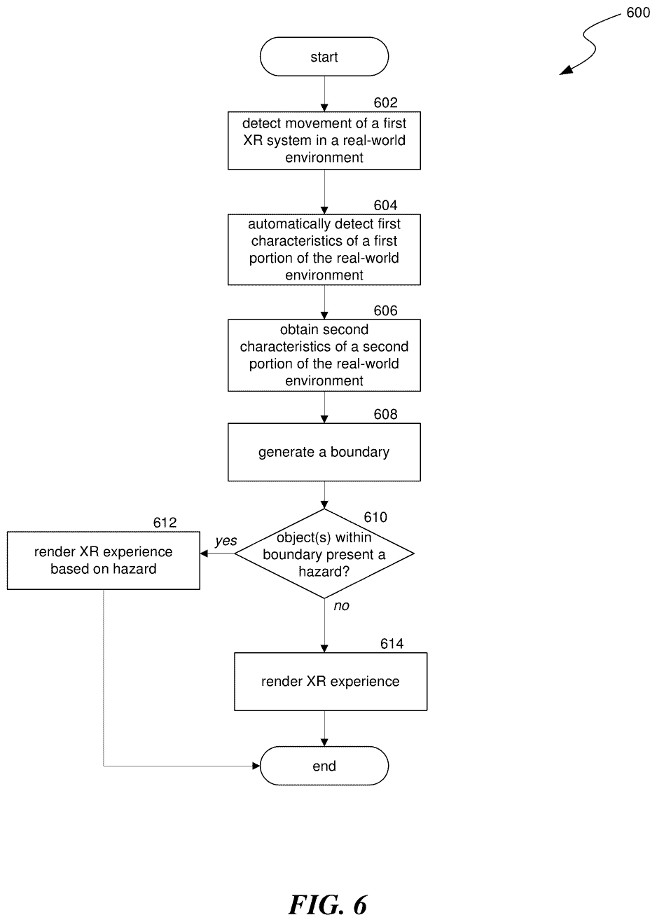

Real-world environment scanning module 436 can automatically detect characteristics of a portion of a real-world environment by at least partially scanning the depth of objects, away from the XR system, in the real-world environment within a fixed radius of the XR system. Real-world environment scanning module 436 can scan the real-world environment while the XR system is stationary and/or as the XR system is being moved, such as when a user of the XR system is traversing and/or looking around the real-world environment. While the XR system is moving, real-world environment scanning module 436 can continually scan the real-world environment within the fixed radius of the XR system, such that a constant area surrounding the XR system (with the XR system at the center) is scanned despite movement of the XR system. Real-world environment scanning module 436 can scan the real-world environment using, for example, one or more cameras, one or more depth sensors, or any combination thereof, which can be included in input/output devices 416. Further details regarding detecting characteristics of a portion of a real-world environment by at least partially scanning the depth of objects away from the XR system in the real-world environment, and within a fixed radius of the XR system, are described herein with respect to blocks 502 and 510 of FIG. 5, and blocks 604 and 606 of FIG. 6.

Boundary generation module 438 can generate a boundary for the real-world environment, scanned by real-world environment scanning module 436, based on the detected characteristics of the scanned real-world environment. In some implementations, the boundary can be referred to interchangeably as a “guardian.” As used herein, a “guardian” can be a defined XR usage space in a real-world environment. If a user, wearing an XR system, crosses the boundary when accessing an XR experience or an object enters the boundary, one or more system actions or restrictions can be triggered on the XR system. For example, the XR system can display a warning message, can activate at least partial pass-through, can display the boundary (or a portion thereof), can pause rendering of or updates to the XR environment, etc., as described further herein. In some implementations, the boundary can be a “mesh” of the real-world space, as defined further herein. In some implementations, boundary generation module 438 can update a generated boundary based on further scanning performed by real-world environment scanning module 436, based on movement of the XR system and/or based on capture of further characteristics of the real-world environment by another XR system, as described further herein. Further details regarding generating a boundary for a real-world environment are described herein with respect to blocks 504 and 512 of FIG. 5, and block 608 of FIG. 6.

Hazard determination module 440 can determine, based on the scanned depth of objects within the boundary generated by boundary generation module 438, whether one or more objects within the boundary present a hazard. Hazard determination module 440 can determine whether object(s) in the boundary present a hazard based on one or more rules. For example, in some cases, hazard determination module 440 can determine that any object within the boundary can present a hazard, such as based on a type of XR experience (e.g., a VR experience requiring a high level of movement, such as an XR dancing experience). In some cases, hazard determination module 440 can determine that only particular objects within the boundary present a hazard, such as objects over a certain height, objects within a threshold distance of the XR system or a user's body part (e.g., within 1 meter), objects that the XR system or a user's body part is approaching, objects that the XR system or a user's body part is approaching at greater than a threshold speed, etc. Further details regarding determining whether one or more objects within a boundary present a hazard are described herein with respect to block 506 of FIG. 5 and block 610 of FIG. 6.

In some implementations, XR experience rendering module 442 can render an XR experience, based, at least partially, on hazard determination module 440 determining that the one or more objects within the boundary present the hazard. In other words, XR experience rendering module 442 can execute the XR experience, relative to the boundary generated by boundary generation module 438, for the real-world environment. In some implementations, the XR experience can be a virtual reality (VR) experience that is a fully immersive, computer-generated artificial environment occupying the entire view of the XR system. In some implementations, the XR experience can be a mixed reality (MR) or augmented reality (AR) experience including virtual objects, overlaid on a view of the real-world environment, that can at least partially obscure an XR system user's view of the real-world environment. If the user wearing the XR system approaches the generated boundary while rendering the XR experience, XR experience rendering module 442 can, for example, cease rendering the XR experience, display the boundary (or a portion thereof, such as a portion within a threshold distance of the XR system) overlaid on the XR experience, fully or partially activate passthrough on the XR system, display a warning, etc., as described further herein. In some implementations, however, upon hazard determination module 440 determining that no objects within the boundary present a hazard, XR experience rendering module 442 can render the XR experience without restriction or further action (e.g., without a warning and/or making other modifications to the XR experience). Further details regarding rendering an XR experience are described herein with respect to blocks 514 and 516 of FIG. 5 and block 614 of FIG. 6.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for automatically generating a boundary for an artificial reality (XR) experience. In some implementations, the XR experience can be a virtual reality (VR) experience. In some implementations, process 500 can be at least partially performed by an XR system including one or more XR devices, such as an XR head-mounted display (HMD) (e.g., XR HMD 200 of FIG. 2A and/or XR HMD 252 of FIG. 2B), one or more external processing components, one or more controllers (e.g., controllers 276A and/or 276B of FIG. 2C), etc. In some implementations, one or more blocks of process 500 can be at least partially performed by a server or computing system remote from the XR system, such as a cloud computing system or edge computing system associated with a platform of the XR system.

In some implementations, process 500 can be performed upon activation or donning of an XR system. In some implementations, process 500 can be performed upon a determination that boundary data and/or hazard data is not available (or is only partially available) for a portion of a real-world environment within a threshold distance (e.g., a fixed radius) of the XR system. In some implementations, process 500 can be performed upon a determination that the XR system has failed to relocalize in the XR environment (e.g., the XR system is in a new real-world environment or does not recognize the real-world environment).

At block 502, process 500 can automatically detect characteristics of a first portion of a real-world environment. In some implementations, process 500 can automatically detect the characteristics of the first portion by at least partially scanning the depth of objects, away from the XR system, in the real-world environment within a fixed radius of the XR system. In some implementations, process 500 can scan the first portion of the real-world environment “in the background,” e.g., without notifying a user of the XR system that it is scanning the real-world space, and/or without instruction or explicit input from the user to scan the real-world environment. In other words, in some implementations, process 500 can scan the real-world environment based on an automatically generated system-level command. In some implementations, an XR application can generate a command to scan the real-world environment, such as through an application programming interface (API) call to the system. In some implementations, at block 502, process 500 does not scan the real-world environment outside the fixed radius of the XR system.

Process 500 can scan the real-world environment via one or more image capture devices (e.g., cameras detecting light in visible and/or invisible wavelength ranges) one or more depth sensors, or any combination thereof, pointed at least partially away from the XR system. In some implementations, process 500 can scan the real-world environment using one or more cameras, without the use of depth sensors, capturing one or more two-dimensional (2D) images of the real-world environment without corresponding depth data, which can later be predicted from features of the 2D images by applying one or more machine learning models. Further details regarding locally applying and updating a trained model for generating depth predictions for 2D images are described further in U.S. patent application Ser. No. 18/454,349 (Attorney Docket No. 3589-0286US01), filed Aug. 23, 2023, entitled “Assisted Scene Capture for an Artificial Reality Environment,” which is herein incorporated by reference in its entirety.

In some implementations, the characteristics of the real-world environment can include visual features of the real-world environment, such as walls, the ceiling, the floor, physical objects within the real-world environment, etc. In some implementations, the characteristics of the real-world environment can be captured as an XR space model (also referred to as a “room box”) corresponding to the real-world space, which can comprise at least one of an XR wall corresponding to the physical wall, an XR ceiling corresponding to the physical ceiling, an XR floor corresponding to the physical floor, or any combination thereof. To obtain the XR space model, the XR system can scan the real-world environment using one or more cameras and/or one or more depth sensors, with process 500 automatically identifying one or more flat surfaces (e.g., walls, floor, ceiling) in the real-world environment using such image and/or depth data. For example, process 500 can identify the flat surfaces by analyzing the image and/or depth data for large areas of the same color, of consistently increasing and/or decreasing depth relative to the XR system, and/or of particular orientations (e.g., above, below, or around the XR system), etc.

In some implementations, process 500 can automatically capture the characteristics of the real-world environment by using depth sensors and/or imaging devices to identify the maximum boundaries of the real-world environment surrounding the XR system. Further details are described in U.S. patent application Ser. No. 18/771,009, filed Jul. 12, 2024, entitled “AUTOMATIC BOUNDARY FOR AN ARTIFICIAL REALITY ENVIRONMENT,” which is herein incorporated by reference in its entirety.

In some implementations, the characteristics of the real-world environment can be captured as a three-dimensional (3D) mesh, corresponding to the scanned real-world space, and stored on the XR system until if or when it is needed to render a VR experience. In some implementations, the mesh can be stored as a grid of one or more interconnected shapes (e.g., squares, triangles, etc.). In some implementations, process 500 can capture both an XR space model and a mesh in order to further refine the mesh, as described further herein. In some implementations, while capturing the XR space model and/or mesh, process 500 need not display the XR space model and/or mesh on the XR system, either while it is being captured and/or when capturing is complete. Further details regarding generating and processing a mesh corresponding to a real-world environment are described in U.S. patent application Ser. No. 18/454,349 (Attorney Docket No. 3589-0286US01), filed Aug. 23, 2023, entitled “Assisted Scene Capture for an Artificial Reality Environment,” which is herein incorporated by reference in its entirety.

In some implementations, process 500 can only scan the real-world environment within a fixed radius of the XR system (and within a field-of-capture of the camera(s) and/or sensor(s) of the XR system, such as away from the XR system). In some implementations, process 500 can scan the real-world environment within the fixed radius as the user changes orientation of the XR system (e.g., as the user looks around). The fixed radius can be any suitable length, such as, for example, 1 meter surrounding outward from the XR system. Although described primarily herein as being “fixed,” it is contemplated that, in some implementations, the radius can extend at variable distances outward relative to the XR system. For example, the radius can, at one or more points, deviate from a predetermined distance by a selected amount, e.g., 10%. In another example, the radius can be larger or smaller at certain points based on one or more factors. For example, the radius can be larger directly in front of the XR system (e.g., at a 20 degree angle extending outward from the current orientation of the XR system) than at other locations. In still another example, the radius can be dynamically changed over time, such as based on a type of XR experience being accessed on the XR system, an amount of movement of the user required by the XR experience (e.g., an XR experience or portion thereof requiring an amount of user movement over a threshold can have a larger radius than an XR experience requiring less user movement, based on greater or lesser likelihood of collision), etc. In some implementations, the size of the radius can be selected based on a known or predicted arm length of the user, step length of the user, etc.

At block 504, process 500 can generate a boundary, for an XR experience, based on the detected characteristics of the first portion of the real-world environment. An “XR experience” and “XR environment,” as used interchangeably herein, can include any VR, MR, or AR experience that includes at least one computer-generated feature (visual, audible, and/or haptic), and that can be controlled at a system-level and/or at an application-level by any number of one or more executing XR applications on the XR system. Although described herein as a boundary for an XR experience for purposes of determining whether objects present a hazard, it is contemplated that the XR experience, as rendered, can extend beyond the generated boundary.

The boundary can be delineated in the real-world environment and define one or more restrictions for the XR experience based on one or more conditions. In some implementations, the boundary can correspond to the generated XR space model, maximum detected boundaries, and/or mesh described above. In some implementations in which a mesh corresponding to the real-world environment is captured, process 500 can further process the generated mesh. In one example, processing the displayed mesh can include collapsing one or more variations in the mesh corresponding to an identified flat surface (e.g., a wall, a ceiling, a floor, or any combination thereof), onto a plane created by the identified flat surface. For example, when scanning the real-world environment, process 500 may incorrectly detect minor discrepancies in the depth of the walls, ceiling, and/or floor, causing the mesh to not lay flat on the surface. In such examples, process 500 can collapse the mesh onto the corresponding flat surface, such that the mesh lays flat without the minor variations in depth. In some implementations, process 500 can identify the corresponding flat surfaces from a generated XR space model.

At block 506, process 500 can determine whether one or more objects within the boundary present a hazard, such as based on the application of one or more rules. The objects can include physical objects in the real-world environment, such as walls, ceiling, floor, furniture, etc., and can be static or moveable (e.g., a child or pet). In some implementations, process 500 can determine that all objects within the boundary present a hazard. In some implementations, process 500 can determine that object(s) within a predefined distance of the XR system present a hazard (e.g., within 1 meter, within a known or predicted arm length of the user, etc.). In some implementations, process 500 can determine that only moveable object(s) present a hazard. In some implementations, process 500 can determine that object(s) having greater than a threshold height, relative to an identified floor, present a hazard (e.g., greater than 5 cm).

In some implementations, process 500 can determine that object(s) are a hazard based on movement of the XR system, and/or one or more body parts of the user of the XR system, toward object(s) (e.g., coming within a threshold distance of an object, approaching an object at greater than a threshold speed, etc.). In some implementations, process 500 can identify the location of body part(s) of the user, and/or their associated movement, relative to object(s) by applying object recognition to one or more images captured by the XR system. In some implementations, process 500 can identify the location of body part(s) of the user, and/or their associated movement, relative to object(s) based on data received from one or more sensors, such as from an inertial measurement unit (IMU) included in controller(s) held by the user and/or wearable device (e.g., smart watch).

If, at block 506, process 500 determines that object(s) within the boundary present a hazard, process 500 can continue to block 516. At block 516, process 500 can render the XR experience based, at least partially, on the determining that the one or more objects within the boundary present the hazard. As noted above, the boundary can define one or more restrictions for the XR environment. For example, by the user of the XR system coming within a threshold distance of an object (delineated by the boundary) and/or crossing the boundary with the XR system and/or one or more detected body parts, process 500 can take one or more actions. In some implementations, the actions can include activating a visual or audible warning overlaid on the XR environment (e.g., “You're too close to the boundary!”) or an instruction to move back away from and/or within the boundary (e.g., “Back up!”). In some implementations, the actions can include pausing at least one of execution, updating, rendering, or any combination thereof, of the XR experience. In some implementations, the actions can include removing one or more virtual objects from the XR environment (e.g., ceasing rendering of virtual objects within the boundary, either associated with the same or a different application). In some implementations, the actions can include activating at least partial pass-through on the XR system, such as corresponding to the identified hazard object(s) and/or an area of the boundary within a threshold distance of the XR system. In some implementations, the actions can include displaying at least one of the one or more boundaries on the XR device (e.g., the boundary corresponding to the object being approached, the entire boundary, or a portion of the boundary within a threshold distance of an XR system), such that the user can visualize where the object(s) are and move away from them. Thus, process 500 can prevent potential injury to the user (or other users or living objects in the real-world environment), damage to physical objects in the real-world environment, etc.

If, at block 506, process 500 determines that object(s) within the boundary do not present a hazard, process 500 can continue to block 508. At block 508, process 500 can determine whether the XR system has moved. Process 500 can determine whether the XR system has moved by any suitable method. For example, process 500 can capture images of the real-world environment over time and determine that the location of the XR system has changed based on the images. In still another example, process 500 can obtain IMU data from the XR system indicating movement of the XR system. In still another example, process 500 can determine that the XR system has moved based on a location of the XR system changing relative to detected spatial anchors for the real-world environment. In some implementations, process 500 can determine that the XR system has moved only when greater than a threshold amount of movement is detected, e.g., greater than 0.2 meters from its previous position, with greater than a threshold amount of velocity, etc.

If, at block 508, process 500 determines that the XR system has not moved, process 500 can continue to block 514. At block 514, process 500 can render the XR experience. In some implementations, based on the determination that no object(s) present a hazard and that the XR system has not moved, process 500 can render the XR experience without restriction(s) as noted above, such as without any visual, audible, or haptic indicators of the boundary and/or of objects within the boundary.

If, at block 508, process 500 determines that the XR system has moved, process 500 can proceed to block 510. At block 510, process 500 can automatically detect characteristics of a second portion of the real-world environment by scanning the depth of objects, away from the XR system, in the real-world environment within the same fixed radius of the XR system (e.g., within 3 meters of the XR system, but centered at its new location). In some implementations, the second portion can be entirely separate from the first portion, while in other implementations, the second portion can at least partially overlap with the first portion (e.g., the XR system has moved a distance less than the size of the fixed radius). Process 500 can detect characteristics of the second portion of the real-world environment in a similar manner as that described above with respect to block 502. In some implementations, at block 510, process 500 does not scan the real-world environment outside the fixed radius of the XR system (i.e., process 500 only scans the second portion of the real-world environment).

At block 512, process 500 can update the generated boundary for the XR experience based on the detected characteristics of the second portion of the real-world environment. The updated boundary can be established within the fixed radius of the new location of the XR system. Process 500 can update the generated boundary in a similar manner as that described above with respect to block 504.

Process 500 can then return to block 506. For example, process 500 can determine, at block 506, that object(s) within the updated boundary present a hazard, and render the XR experience based on the hazard at block 516. In another example, process 500 can determine, at block 506, that object(s) within the updated boundary do not present a hazard, and process 500 can continue at block 508, and so on and so forth.

In some implementations, and at any point in process 500, process 500 can determine that the XR system has less than a threshold amount of movement in the real-world environment. Based on the determining that the XR system has less than the threshold amount of movement in the real-world environment and/or determining a posture of the user as a non-standing posture (e.g., based on tracking a height of the XR device moving below a threshold, based on tracking user body parts and matching them to a seated or laying down posture, etc.), process 500 can switch the XR system from a “moveable mode” described above to a “stationary mode” in which the real-world environment is not further scanned and/or the generated boundary is not updated. In some implementations, the XR system can operate in the moveable mode when process 500 detects greater than a threshold amount of movement of the XR system (e.g., the user is moving about the real-world environment while rendering the XR experience). Process 500 can detect movement of the XR system via, for example, one or more images captured by the XR system over time (e.g., from an XR HMD and/or an external image capture device), one or more sensors of an inertial measurement unit (IMU) integral with the XR system, etc. For example, process 500 can detect that the user is not fixed to a particular pivot point in the XR environment, e.g., is moving greater than a threshold amount in the x-, y-, and/or z-directions.

In the stationary mode, for example, process 500 can detect that the user is fixed to a particular pivot point in the XR environment, thereby indicating the user is in a seated or standing posture, e.g., is moving less than a threshold amount in the x-, y-, and/or z-directions, as detected from one or more images, one or more sensors of an IMU, etc. In some cases, detecting a stationary posture can be based, at least in part, on the XR device being below a threshold height for a threshold amount of time. In some implementations, process 500 can alternatively or additionally detect a seated or standing posture by analyzing one or more images, e.g., by capturing and detecting the user's legs in a seated or standing posture. In order for the XR system to remain in the stationary mode, the user must remain fixed to the pivot point, and/or only move a threshold amount from the pivot point.

In some implementations, process 500 can recommend and/or notify the user of the determined mode via the XR system, such as via display of a prompt and/or an audible announcement, although in some implementations, such recommendation and/or notification is not necessary. In some implementations, process 500 can modify the determined mode based on input by the user received via the XR system. For example, the user can request that the XR experience be executed in moveable mode instead of stationary mode or vice versa.

In some implementations, at any point in process 500, process 500 can display the detected characteristics of the real-world environment and/or the generated boundary on the XR system. In some implementations, after displaying the generated boundary, process 500 can modify the generated boundary. For example, process 500 can receive input by the user of the XR system to make one or more manual adjustments to the generated boundary, at least in part, via detected positions of one or more controllers (e.g., controller 276A and/or controller 276B of FIG. 2C) and/or tracked hand or other body part positions. For example, the user of the XR system can move the controllers or body parts around the real-world environment to, for example, outline a correct position of the walls, ceiling, and/or floor with a ray projected from a controller. In another example, the user of the XR system can set the controller or body parts on the correct position of the walls, ceiling, and/or floor to identify them based on the position of the controller or body part (e.g., as detected by one or more cameras on the XR device, as detected via one or more sensors of an IMU, etc.). In some implementations, the user of the XR system can pinch (with a hand) or select (with a controller) a predicted wall, ceiling, and/or floor, and drag the wall, ceiling, and/or floor to the correct position. Further details regarding capturing and realigning a generated boundary are described in U.S. patent application Ser. No. 18/346,379, filed Jul. 3, 2023, entitled “Artificial Reality Room Capture Realignment,” which is herein incorporated by reference in its entirety.

FIG. 6 is a flow diagram illustrating a process 600 used in some implementations of the present technology for generating a boundary, using data from multiple XR systems, for an XR experience. In some implementations, process 600 can be at least partially performed by an XR system including one or more XR devices, such as an XR head-mounted display (HMD) (e.g., XR HMD 200 of FIG. 2A and/or XR HMD 252 of FIG. 2B), one or more external processing components, one or more controllers (e.g., controllers 276A and/or 276B of FIG. 2C), etc. In some implementations, one or more blocks of process 600 can be at least partially performed by a server or computing system remote from the XR system, such as a cloud computing system or edge computing system associated with a platform of the XR system.

In some implementations, process 600 can be performed upon activation or donning of an XR system. In some implementations, process 600 can be performed upon a determination that boundary data and/or hazard data is not available (or is only partially available) for a portion of a real-world environment within a threshold distance (e.g., a fixed radius) of the XR system. In some implementations, process 600 can be performed upon a determination that the XR system has failed to relocalize in the XR environment.

At block 602, process 600 can detect movement of a first XR system in a real-world environment. Process 600 can detect movement of the first XR system in a similar manner as described with respect to block 508 of FIG. 5.

At block 604, process 600 can automatically detect first characteristics of a first portion of the real-world environment by scanning the depth of objects, away from the first XR system, that are within a fixed radius of the first XR system in the real-world environment. Process 600 can automatically detect the first characteristics of the first portion of the real-world environment in a similar manner as that described with respect to blocks 502 and/or 510 of FIG. 5.

At block 606, process 600 can obtain second characteristics of a second portion of the real-world environment. The second characteristics can be detected by a second XR system (separate from the first XR system) by scanning the depth of objects, away from the second XR system, that are within the fixed radius of the first XR system (and, in some implementations, within the fixed radius of the second XR system) in the real-world environment. The second characteristics can be detected by the second XR system in a similar manner as that described with respect to the first characteristics detected by the first XR system. Thus, in some implementations, process 600 can obtain characteristics of a portion of the real-world environment, within its fixed radius, but that cannot be detected by the first XR system (e.g., an area behind the first XR system detectable by the second XR system based on its location and/or orientation). In some implementations, the second portion of the real-world environment can correspond to an area within the same fixed radius used by the first XR system to detect the first characteristics (e.g., 3 meters surrounding the second XR system).

In some implementations, process 600 can align a location of the first XR system into a localization map, corresponding to the real-world environment, the localization map including the location of the second XR system. Process 600 can align itself (and/or the second XR system can align itself) in the localization map based on, for example, detection of one or more spatial anchors established for the real-world space, visual features in the real-world environment captured by the respective XR system, etc. In some implementations, the localization map can be a simultaneous location and mapping (SLAM) map. In some implementations, the localization map can further include indications of the depth of objects scanned by the first and second XR systems (and/or other XR systems), which, in some cases, can have corresponding timestamps when the depth of objects were scanned. Thus, in some implementations, process 600 can only obtain (and/or use to generate a boundary, as described further herein) characteristics of the second portion that were detected by the second XR system more recently than some or all of characteristics of the second portion detected by the first XR system. In some implementations, the second characteristics can include a location of the second XR system and/or at least one location of at least a portion of a body of the user of the second XR system (e.g., hand(s), arm(s), feet, etc.), as ascertained from, e.g., visual data captured by the second XR system, such that collision between the two XR systems and/or their respective users can be avoided.

At block 608, process 600 can generate a boundary, for an XR experience, based on the detected first characteristics and the detected second characteristics. In some implementations, process 600 can only obtain or use some or all of the second characteristics to generate the boundary if they were not previously detected by the first XR system. In some implementations, process 600 can only use some or all of the second characteristics to generate the boundary if they were detected by the second XR system more recently than any characteristics of the second portion detected by the first XR system, as noted above. Further details regarding generating a boundary for an XR system using detected and/or obtained characteristics are described herein with respect to blocks 504 and 512 of FIG. 5.

At block 610, process 600 can determine, based on the scanned depths of objects within the generated boundary, whether one or more objects within the boundary present a hazard. Process 600 can determine whether one or more objects within the boundary present a hazard in a similar manner as that described with respect to block 506 of FIG. 5.

If, at block 610, process 600 determines that object(s) within the boundary do not present a hazard, process 600 can proceed to block 614. At block 614, process 600 can render the XR experience without restriction. Process 600 can render the XR experience in a similar manner as that described with respect to block 514 of FIG. 5.

If, at block 610, process 600 determines that object(s) within the boundary present a hazard, process 600 can proceed to block 612. At block 612, process 600 can render the XR experience based, at least partially, on the determining that the one or more objects within the generated boundary present the hazard. Process 600 can render the XR experience based on the determining that the object(s) within the generated boundary present the hazard in a similar manner as that described with respect to block 516 of FIG. 5.

Although illustrated in FIG. 6 as a single loop, it is contemplated that process 600 can return to block 602 and determine whether movement has occurred; detect characteristics of the real-world environment within the fixed radius of the XR system at the new location; and update the generated boundary, such as is described further herein with respect to FIG. 5. In some implementations, upon detecting movement of the XR system, process 600 can obtain further characteristics of the new portion of the real-world environment from one or more other XR systems as well, such as is described with respect to block 606, and use such further characteristics to update the generated boundary.

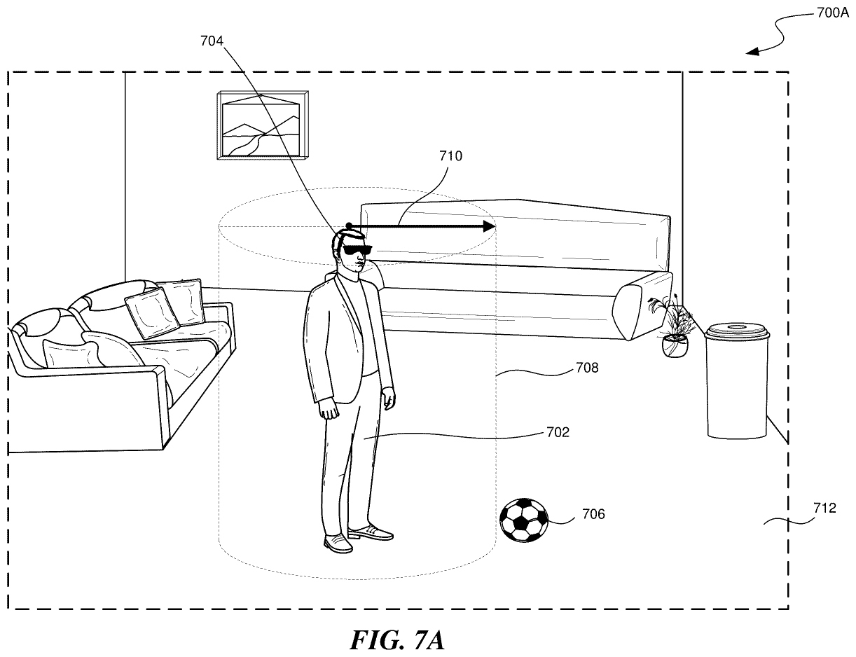

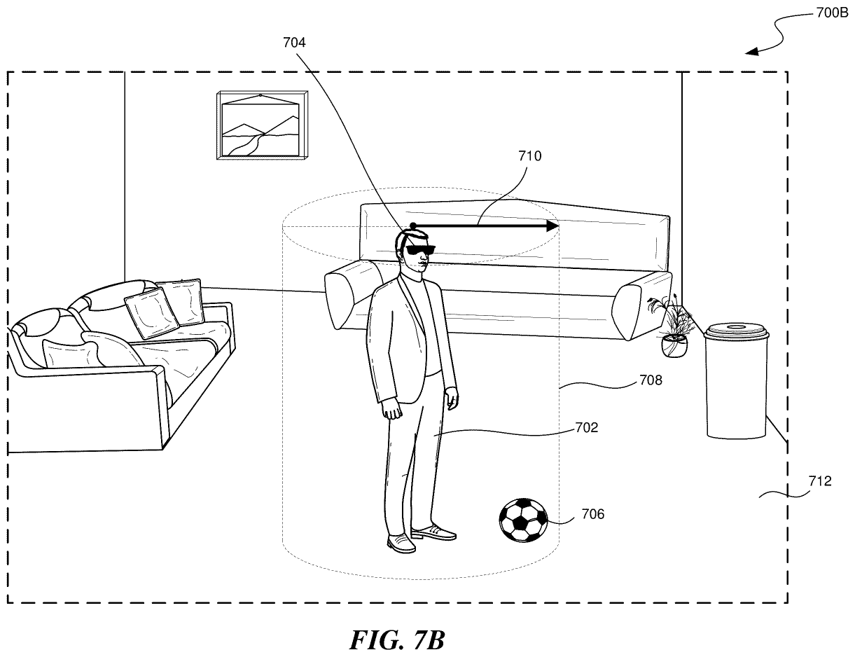

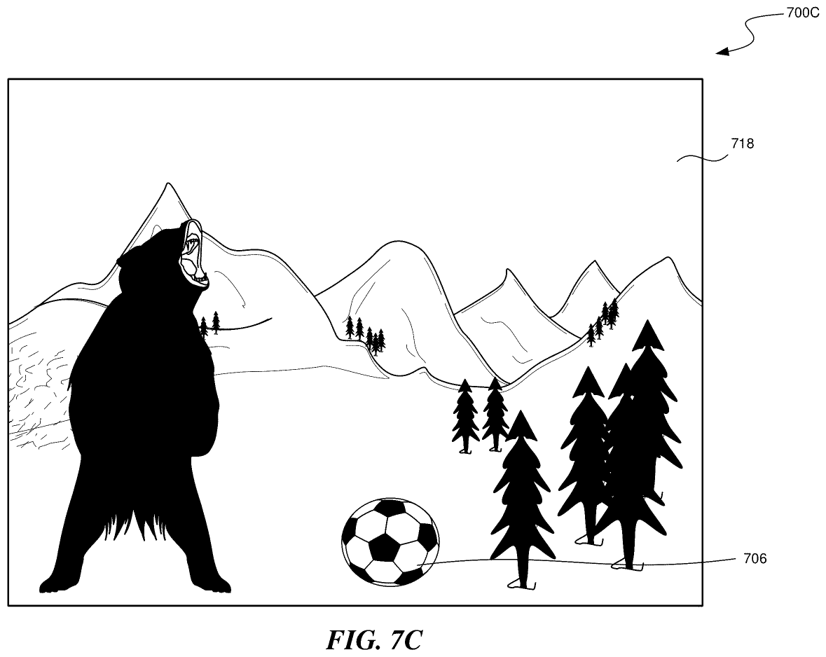

FIG. 7A is a conceptual diagram illustrating an example view of a real-world environment 700A in which an XR system 704 has generated a boundary 708, having a fixed radius 710, surrounding the XR system 704 and for accessing an XR experience (e.g., XR experience 718 of FIG. 7C), within which no hazard is detected. For example, XR system 704 can automatically detect characteristics of a first portion of a real-world environment (corresponding to the portion within boundary 708) by at least partially scanning the depth of objects, away from XR system 704, in real-world environment 700A within fixed radius 710. XR system 704 can then generate boundary 708 corresponding to the fixed radius 710 surrounding XR system 704.

In the example shown in FIG. 7A, XR system 704 can identify floor 712, for example, within boundary 708. However, XR system 704 can determine that floor 712 does not present a hazard based on one or more rules, e.g., that floors are excluded as being hazards, that floor 712 has a constant height (e.g., no steps, stairs, or other variances in height greater than a threshold, etc.), and/or the like. In this example, XR system 704 does not scan outside of boundary 708, and thus does not detect objects outside of boundary 708, such as ball 706.

FIG. 7B is a conceptual diagram illustrating an example view of a real-world environment 700B in which an XR system 704 has generated a fixed-radius 710 boundary 708, surrounding the XR system 704 and for accessing an XR experience (e.g., XR experience 718 of FIG. 7C), within which a hazard is detected. Relative to FIG. 7B, user 702 (and correspondingly, XR system 704) can move forward in real-world environment 700B toward ball 706. XR system 704 can detect its movement via, for example, data collected from an accelerometer, a gyroscope, a camera, etc., integral with XR system 704. Based on the detected movement, XR system 704 can automatically detect characteristics of a second portion of real-world environment 700B (corresponding to the portion within boundary 708) by at least partially scanning the depth of objects, away from XR system 704, in real-world environment 700A within fixed radius 710. XR system 704 can then update boundary 708 corresponding to the fixed radius 710 surrounding XR system 704.

In the example shown in FIG. 7B, XR system 704 can identify floor 712 and ball 706 within boundary 708. However, XR system 704 can determine that floor 712 does not present a hazard based on one or more rules, as described further above. In this example, XR system 704 can further identify that ball 706, within updated boundary 708, presents a hazard based on one or more rules. The rule(s) can specify, for example, that any object over a threshold height from floor 712 is a hazard, that any object within boundary 708 is a hazard, that any object within a threshold distance of user 702 is a hazard (e.g., 2 meters), and/or the like. XR system 704 does not scan outside of boundary 708, and thus does not detect other objects outside of boundary 708. Although shown and described relative to FIGS. 7A and 7B as being cylindrical in shape, it is contemplated that, in some implementations, boundary 708 can have a semi-spherical top, extending the same fixed radius 710 from the top of XR system 704 in a y-direction perpendicular to floor 712. Thus, low hanging objects (e.g., ceiling lamps) that may present a hazard to user 702 (such as if the user jumps or raises their arm) can also be identified by XR system 704 within boundary 708.

FIG. 7C is a conceptual diagram illustrating an example view 700C, on an XR system 704, of an XR experience 718 (in this case, a VR experience) in which a hazard, detected within a fixed-radius 710 boundary 708 of the XR system 704, is rendered in pass-through. For example, as described above with respect to FIG. 7B, XR system 704 can determine that ball 706, within boundary 708, is a hazard to user 702. Thus, XR system 704 can take one or more actions and/or enforce one or more restrictions relative to XR experience 718, e.g., showing ball 706, from real-world environment 700B, in pass-through in XR experience 718, such that user 702 can view and avoid collision with ball 706.

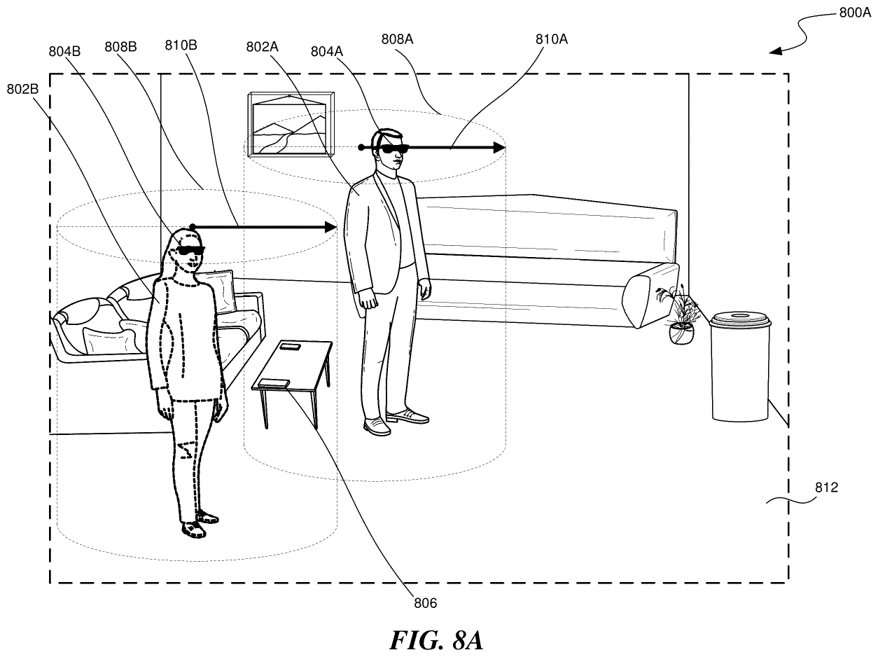

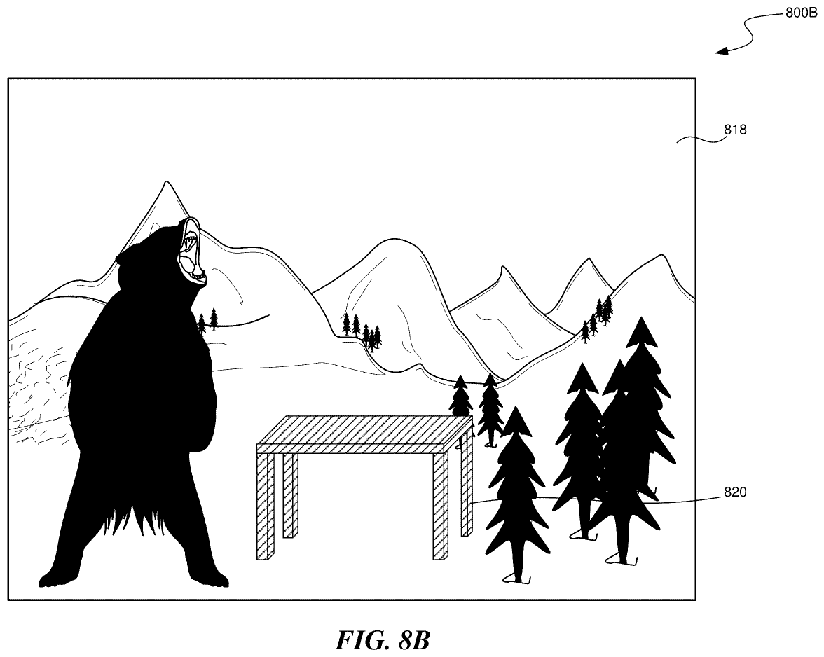

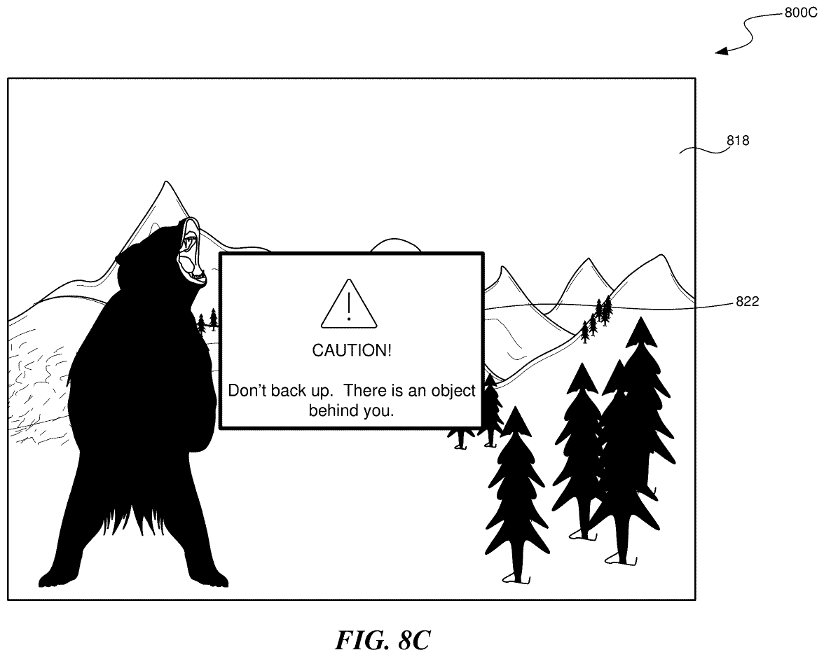

FIG. 8A is a conceptual diagram illustrating an example view of a real-world environment 800A in which two XR systems 804A, 804B have generated respective fixed-radius 810A, 810B boundaries 808A, 808B, and within which one XR system 804B detects a hazard within both boundaries 808A, 808B. First XR system 804A can automatically detect first characteristics of a first portion of real-world environment 800A (corresponding to the area within boundary 808A), such as by scanning, via one or more depth sensors, objects within radius 810A of first XR system 804A and away from first XR system 804A. In the example illustrated in FIG. 8A, first XR system 804A can scan the area within the first portion of the real-world environment that is capturable by first XR system 804A, e.g., the area in front of first XR system 804A. Because user 802A has not turned around, the area behind first XR system 804A cannot be scanned; thus, first XR system 804A cannot detect table 806 in real-world environment 800A.

Similarly, second XR system 804B can automatically detect second characteristics of a second portion of real-world environment 800A (corresponding to the area within boundary 808B), such as by scanning, via one or more depth sensors, objects within radius 810B of second XR system 804B and away from second XR system 804B. In the example illustrated in FIG. 8B, second XR system 804B can scan the area within the second portion of the real-world environment that is capturable by second XR system 804B, e.g., the area in front of first XR system 804B. In this example, second XR system 804B can detect table 806 within both boundary 808B and boundary 808A, which cannot be detected by first XR system 804A.

In some implementations, first XR system 804A can obtain the second characteristics, either directly or indirectly (e.g., through a remote computing system) from second XR system 804B. First XR system 804A can then generate boundary 808A, which, in some implementations, can be a three-dimensional mesh outlining the bounds of real-world environment 800A within fixed radius 810A of first XR system 804A, including an indication of table 806 within boundary 808A. Second XR system 804B can similarly generate boundary 808B as a mesh outlining the bounds of real-world environment 800A within fixed radius 810B of second XR system 804B. In some implementations, fixed radii 810A, 810B can be the same preset distance (e.g., 3 meters), can be a user- or system-selected and/or adjustable distance, and/or can be a distance selected based on one or more attributes of users 802A and/or 802B (e.g., a known or predicted arm length or step length). First XR system 804A and/or second XR system 804B can further determine, within their respective boundary 808A, 808B, that table 806 presents a hazard based on one or more rules. The rule(s) can specify, for example, that any object over a threshold height from floor 812 is a hazard, that any object within respective boundary 808A, 808B is a hazard, that any object within a threshold distance of respective user 802A, 802B is a hazard (e.g., 3 meters), and/or the like. First XR system 804A and second XR system 804B do not scan outside of their respective boundaries 808A, 808B, and thus do not detect other objects outside of their respective boundaries 808A, 808B.

FIG. 8B is a conceptual diagram illustrating an example view 800B, on a second XR system 804B, of an XR experience 818 (in this case, a VR experience) in which a hazard, detected with a fixed-radius boundary 808B of the second XR system 804B, is rendered as a mesh 820. For example, as described above with respect to FIG. 8A, second XR system 804B can determine that table 806, within boundary 808B, is a hazard to second user 702B. Thus, second XR system 804B can take one or more actions and/or enforce one or more restrictions relative to XR experience 818, e.g., displaying mesh 820 corresponding to table 806 within boundary 808B, such that second user 802B can visualize and avoid collision with table 806.

FIG. 8C is a conceptual diagram illustrating an example view 800C, on a first XR system 804A, of an XR experience 818 in which a warning 822 of a hazard is displayed, based on the hazard being detected by a second XR system 804B within a fixed-radius boundary 808A of the first XR system 804A. For example, as described above with respect to FIG. 8A, first XR system 804A can obtain additional characteristics of the first portion of real-world environment 800A (corresponding to boundary 808A) captured by second XR system 804B within the second portion of real-world environment 800A (corresponding to boundary 808B); e.g., table 806 behind first XR system 804A and not captured by first XR system 804A. Based on these determined characteristics, first XR system 804A can determine that table 806, behind first user 802A and within boundary 808A, is a hazard based on one or more rules described above. Thus, first XR system 804A can take one or more actions and/or enforce one or more restrictions relative to XR experience 818, e.g., displaying warning 822 that table 806 is within boundary 808A and behind first user 802A, such that first user 802A can avoid collision with table 806.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for automatically generating a boundary for an artificial reality experience, the method comprising:
automatically detecting, by an artificial reality system, characteristics of a first portion of a real-world environment by at least partially scanning the depth of objects, away from the artificial reality system, in the real-world environment within a fixed radius of the artificial reality system;
generating the boundary, for the artificial reality experience, based on the detected characteristics of the first portion of the real-world environment;
determining, based on the scanned depth of objects within the boundary, that the objects within the boundary do not present a hazard;
detecting movement of the artificial reality system;
based on the detecting movement of the artificial reality system, automatically detecting, by the artificial reality system, characteristics of a second portion of the real-world environment by scanning the depth of objects, away from the artificial reality system, in the real-world environment within the fixed radius of the artificial reality system;
updating the generated boundary, for the artificial reality experience, based on the detected characteristics of the second portion of the real-world environment;
determining, based on the scanned depth of objects within the updated boundary, that one or more objects within the updated boundary present a hazard; and
rendering the artificial reality experience based, at least partially, on the determining that the one or more objects within the updated boundary present the hazard.

2. The method of claim 1, wherein the determining that the one or more objects presents the hazard includes determining that the one or more objects, within the updated boundary, are within a threshold distance of the artificial reality system.

3. The method of claim 2, wherein rendering the artificial reality experience includes rendering a representation of the one or more objects.

4. The method of claim 3, wherein the representation of the one or more objects includes a mesh outlining the one or more objects.

5. The method of claim 4, wherein the mesh is a three-dimensional mesh of the one or more objects.

6. The method of claim 3, wherein the representation of the one or more objects includes a pass-through view of the one or more objects.

7. The method of claim 1, wherein the determining that the one or more objects presents the hazard includes determining that the artificial reality system is moving toward the one or more objects within the updated boundary.

8. The method of claim 1,
wherein, when automatically detecting by the artificial reality system characteristics of the first portion of a real-world environment, the artificial reality system does not analyze data for depths outside the fixed radius of the artificial reality system.

9. The method of claim 1, further comprising:
determining that the artificial reality system has less than a threshold amount of movement in the real-world environment and/or determining a posture of the user as a non-standing posture; and
based on the determining that the artificial reality system has less than the threshold amount of movement in the real-world environment and/or determining a posture of the user as a non-standing posture, switching to a stationary mode in which the real-world environment is not further scanned and/or the generated boundary is not further updated.

10. The method of claim 1, further comprising:
obtaining additional characteristics of the first portion of the real-world environment, within the fixed radius of the artificial reality system, detected by an other artificial reality system at least partially scanning the first portion of the real-world environment,
wherein the updating the generated boundary is further based on the additional characteristics of the first portion of the real-world environment.

11. The method of claim 10, wherein the additional characteristics correspond to an area, of the second portion of the real-world environment, not scanned by the artificial reality system.

12. A computer-readable storage medium storing instructions, for automatically generating a boundary for an artificial reality experience, the instructions, when executed by a computing system, cause the computing system to:
detect movement of an artificial reality system in a real-world environment;
based on the detecting movement of the artificial reality system, automatically detect, by the artificial reality system, characteristics of a portion of the real-world environment by scanning the depth of objects, away from the artificial reality system, in the real-world environment within a fixed radius of the artificial reality system;
generate the boundary, for the artificial reality experience, based on the detected characteristics of the portion of the real-world environment;
determine, based on the scanned depth of objects within the generated boundary, that one or more objects within the generated boundary present a hazard; and
render the artificial reality experience based, at least partially, on the determining that the one or more objects within the generated boundary present the hazard.

13. The computer-readable storage medium of claim 12, wherein the instructions, when executed by the computing system, further cause the computing system to:
obtain additional characteristics of the portion of the real-world environment, within the fixed radius of the artificial reality system, detected by an other artificial reality system at least partially scanning the portion of the real-world environment,
wherein the generating the boundary is further based on the additional characteristics of the portion of the real-world environment.

14. The computer-readable storage medium of claim 13, wherein the additional characteristics correspond to an area, of the portion of the real-world environment, not scanned by the artificial reality system.

15. The computer-readable storage medium of claim 12,
wherein, when automatically detecting by the artificial reality system characteristics of the portion of a real-world environment, the artificial reality system does not analyze data for depths outside the fixed radius of the artificial reality system.

16. A computing system for automatically generating a boundary for an artificial reality experience, the computing system comprising:
one or more processors; and
one or more memories storing instructions that, when executed by the one or more processors, cause the computing system to:
detect movement of an artificial reality system in a real-world environment;
based on the detecting movement of the artificial reality system, automatically detect, by the artificial reality system, characteristics of a portion of the real-world environment by scanning the depth of objects, away from the artificial reality system, in the real-world environment within a fixed radius of the artificial reality system;
generate the boundary, for the artificial reality experience, based on the detected characteristics of the portion of the real-world environment;
determine, based on the scanned depth of objects within the generated boundary, that one or more objects within the generated boundary present a hazard; and
render the artificial reality experience based, at least partially, on the determining that the one or more objects within the generated boundary present the hazard.

17. The computing system of claim 16, wherein the determining that the one or more objects presents the hazard includes determining that the one or more objects, within the generated boundary, are within a threshold distance of the artificial reality system.

18. The computing system of claim 17, wherein rendering the artificial reality experience includes rendering a representation of the one or more objects.

19. The computing system of claim 18, wherein the representation of the one or more objects includes a mesh outlining the one or more objects.

20. The computing system of claim 18, wherein the representation of the one or more objects includes a pass-through view of the one or more objects.
